(19) United States
(12) Patent Application Publication
(10) Pub. No.: US 2016/0117616 A1
(43) Pub. Date: Apr. 28, 2016

(54) DETERMINING ALTERNATIVE TRAVEL ITINERARIES USING WEATHER INFORMATION

(71) Applicant: Google Inc., Mountain View, CA (US)

(72) Inventors: Yi Wang, Acton, MA (US); Stephen Leslie Peters, Cambridge, MA (US); Nick Ning, Bedford, MA (US)

(21) Appl. No.: 14/521,026

(22) Filed: Oct. 22, 2014

(51) Int. Cl. G06Q 10/02

(52) U.S. Cl. CPC G06Q 10/025

(57) ABSTRACT

Methods, systems, and apparatus, including computer programs encoded on a computer storage medium, for detecting travel information. In one aspect, a method includes obtaining current flight status information for plural flights and using the information to determine that a user's flight itinerary is delayed or canceled, determining alternative flight itineraries to the flight itinerary, and providing alternative flight itineraries for display on a user device. Determining alternative flight itineraries includes obtaining and ranking candidate alternative flight itineraries that occur within a specified time frame and that correspond to an origin and destination in the user's flight itinerary, obtaining and using weather information to determine particular candidate alternative flight itineraries having high-risk connections, weighting high-risk itineraries to generate a group of alternative flight itineraries, adjusting the ranking based on the weighting, and selecting highest-ranked candidates to generate a group of alternative flight itineraries.

### BACKGROUND

This specification relates to information retrieval.

Conventional online travel booking sites allow users to identify and purchase travel according to a specified itinerary. For example, a user can purchase one or more tickets for airline flights associated with a flight itinerary, with each flight departing from a first location at a particular date and time and arriving at another location at a particular date and time. Following the purchase of a particular flight itinerary, the user will typically follow the flight itinerary and complete the trip.

Existing flight itineraries can be affected by different factors, many of which may be out of control of the user. For example, flight delays and/or cancellations can be caused by weather conditions, equipment problems, and/or other factors. Flight delays can occur in (or be predicted at) various parts of an itinerary, such as before travel occurs or at some time after travel has commenced.

### SUMMARY

This specification describes technologies relating to determining alternative travel itineraries.

Travel itineraries can include specific modes of transportation and associated times. For example, a travel itinerary associated with airline travel can include flight information, carrier information, and dates/times of departures and arrivals.

A system can be used to determine re-accommodations, such as if a current travel itinerary in use by a traveling user is affected by one or more factors or events. For example, a user may complete part of a travel itinerary from City A to City C, such as a first leg flying from City A to City B. A flight from one point to another point is typically referred to as a leg. A flight from an origin location to a destination location can have one or more distinct legs. Thus, there may be a layover in City B for a connecting flight to City C as a second leg of the travel itinerary. In some cases, one or more problems may exist that are associated with the connecting flight, such as a problem with equipment, personnel, weather or some other problem that may cause the connecting flight to be canceled or delayed. At this time, the system can recommend a change in the user's flight itinerary that is based on the cancellation or delay. In some implementations, the recommendation can further be based on weather information. For example, weather information can be used to determine particular candidate alternative flight itineraries that have high-risk connections, such as itineraries that include flights with departures and/or arrivals in locations affected by adverse weather. High-risk itineraries can be weighted to generate a group of alternative flight itineraries, including using weighting that contributes to the non-selection of the high-risk itineraries.

In some implementations, current weather information can be received from various sources, such as weather services, and storms and/or other weather events or conditions can be forecast over several hours in a specific geographic area. The received weather information can be used in different ways to affect the selection of alternative flight itineraries.

In some implementations, a determination is made that a connection at a particular airport or city is high-risk. The determination that a connection is high-risk may be based on both the existing flight information and a likelihood of inclement weather (e.g., thunderstorms, snowstorms, fog, or other conditions) at the airport location at or near a time of arrival or departure. The likelihood of inclement weather, for example, can be used to identify a probability of more risky connections, including information that can exist even before airlines and/or other agencies provide information about a flight delay or cancellation.

In some implementations, a list of alternative flights can be pruned to avoid connecting through airports that may experience a weather delay. For example, pruning the list of alternative flights can be based on information associated with the likelihood of inclement weather (e.g., an approaching storm) at or near a particular airport, city or region.

In some implementations, e.g., when pruning a list of alternatives flights, flight connections in either the original itinerary or in the generated alternatives can be evaluated automatically based on existing weather events and/or forecasts. For example, for each city associated with a connection, the evaluation can include generating an internal probability of a given storm affecting the area. At that point, the probability can be used along with an estimate of a delay associated with the storm, such as to calculate an expected take-off and/or landing delay for the flights in question. If the expected delay will seem to affect the flights such that the connection is impossible or tight, then the connection can be indicated as being high-risk.

In some implementations, the risk that is determined for a particular expected delay can factor in known or historical capabilities of a city and/or airport to deal with a particular type of weather condition. For example, a small amount of snow in a Midwest airport may cause little or no risk as compared to Atlanta where snow is less frequent.

In some implementations, information for weather events for one city can be used to determine storm-affect probabilities of other cities that do not have weather problems but may be affected by cities that do. For example, determined probabilities can factor in the potential unavailability of equipment (e.g., planes) or flight personnel stranded in one city (e.g., where the storm is) but needed at a different city (e.g., where the weather is fair) later in the day.

For the original itinerary, higher-risk connections or flights that are impacted by weather can be marked as problematic and presented (e.g., in a user interface) as needing alternatives. For alternatives, higher-risk connections and flights can be pruned from the list of results (or, alternately, marked as such in the list of possibilities). In some implementations, risk scores and/or descriptive reasons associated with a city and/or connection can be generated and presented to the user with other information associated with alternative flight itineraries. The user can use such presented information to understand, for example, why a presented alternative flight itinerary goes through Minneapolis and not Omaha.

In general, one innovative aspect of the subject matter described in this specification can be embodied in methods that include the actions of obtaining current flight status information for a plurality of flights; using the current flight status information to determine that a flight itinerary of a user is delayed or canceled; determining one or more alternative flight itineraries to the flight itinerary that is delayed or canceled, including obtaining a collection of candidate alternative flight itineraries occurring within a specified time frame and that correspond to an origin and destination of the user itinerary, ranking the collection of candidate alternative flight itineraries according to one or more criteria, obtaining weather information, using the weather information to determine particular candidate alternative flight itineraries having high-risk connections, weighting high-risk itineraries to generate a group of alternative flight itineraries, adjusting the ranking based on the weighting, and selecting a specified number of highest-ranked candidates to generate a group of alternative flight itineraries; and providing one or more of the group of alternative flight itineraries for display on a user device. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can each optionally include one or more of the following features. Determining one or more alternative flight itineraries comprises determining current flight status information for a specified number of highest-ranked candidate alternative flight itineraries and filtering the highest-ranked candidate alternative flights based on the current flight status to generate a group of alternative flight itineraries. The obtained weather information includes weather predictions for particular weather events in proximity to connecting airport locations in the collection of candidate alternative flight itineraries and corresponding flight times. The particular weather events include one or more of hurricanes, thunderstorms, or snowstorms. Determining particular candidate alternative flight itineraries as having high-risk connections comprises an estimate of delay for each connection based on the weather and comparing the estimated delay to a connection threshold. Providing one or more of the group of alternative flight itineraries for display includes providing an indicator for display with particular alternative flight itineraries indicating potential weather delays.

In general, another innovative aspect of the subject matter described in this specification can be implemented in methods that include another computer-implemented method for providing creatives. The method includes obtaining a user flight itinerary. The method further includes obtaining weather information. The method further includes using the flight itinerary of a user and the obtained weather information to determine one or more alternative flight itineraries to the flight itinerary of the user. The method further includes obtaining a collection of candidate alternative flight itineraries occurring within a specified time frame and that correspond to an origin and destination of the user itinerary. The method further includes ranking the collection of candidate alternative flight itineraries according to one or more criteria. The method further includes using the weather information to determine particular candidate alternative flight itineraries having high-risk connections. The method further includes weighting high-risk itineraries to generate a group of alternative flight itineraries. The method further includes adjusting the ranking based on the weighting. The method further includes selecting a specified number of highest-ranked candidates to generate a group of alternative flight itineraries. The method further includes providing one or more of the group of alternative flight itineraries for display on a user device as suggested alternative flight itineraries.

In general, another innovative aspect of the subject matter described in this specification can be implemented in computer program products that include a computer program product tangibly embodied in a computer-readable storage device and comprising instructions. The instructions, when executed by one or more processors, cause the processor to perform operations including: obtaining current flight status information for a plurality of flights; using the current flight status information to determine that a flight itinerary of a user is delayed or canceled; determining one or more alternative flight itineraries to the flight itinerary that is delayed or canceled, including obtaining a collection of candidate alternative flight itineraries occurring within a specified time frame and that correspond to an origin and destination of the user itinerary, ranking the collection of candidate alternative flight itineraries according to one or more criteria, obtaining weather information, using the weather information to determine particular candidate alternative flight itineraries having high-risk connections, weighting high-risk itineraries to generate a group of alternative flight itineraries, adjusting the ranking based on the weighting, and selecting a specified number of highest-ranked candidates to generate a group of alternative flight itineraries; and providing one or more of the group of alternative flight itineraries for display on a user device.

These and other implementations can each optionally include one or more of the following features. Determining one or more alternative flight itineraries comprises determining current flight status information for a specified number of highest-ranked candidate alternative flight itineraries and filtering the highest-ranked candidate alternative flights based on the current flight status to generate a group of alternative flight itineraries. The obtained weather information includes weather predictions for particular weather events in proximity to connecting airport locations in the collection of candidate alternative flight itineraries and corresponding flight times. The particular weather events include one or more of hurricanes, thunderstorms, or snowstorms. Determining particular candidate alternative flight itineraries as having high-risk connections comprises an estimate of delay for each connection based on the weather and comparing the estimated delay to a connection threshold. Providing one or more of the group of alternative flight itineraries for display includes providing an indicator for display with particular alternative flight itineraries indicating potential weather delays.

In general, another innovative aspect of the subject matter described in this specification can be implemented in systems, including a system comprising one or more processors and one or more memory elements including instructions. The instructions, when executed, cause the one or more processors to perform operations including: obtaining current flight status information for a plurality of flights; using the current flight status information to determine that a flight itinerary of a user is delayed or canceled; determining one or more alternative flight itineraries to the flight itinerary that is delayed or canceled, including obtaining a collection of candidate alternative flight itineraries occurring within a specified time frame and that correspond to an origin and destination of the user itinerary, ranking the collection of candidate alternative flight itineraries according to one or more criteria, obtaining weather information, using the weather information to determine particular candidate alternative flight itineraries having high-risk connections, weighting high-risk itineraries to generate a group of alternative flight itineraries, adjusting the ranking based on the weighting, and selecting a specified number of highest-ranked candidates to generate a group of alternative flight itineraries; and providing one or more of the group of alternative flight itineraries for display on a user device.

These and other implementations can each optionally include one or more of the following features. Determining one or more alternative flight itineraries comprises determining current flight status information for a specified number of highest-ranked candidate alternative flight itineraries and filtering the highest-ranked candidate alternative flights based on the current flight status to generate a group of alternative flight itineraries. The obtained weather information includes weather predictions for particular weather events in proximity to connecting airport locations in the collection of candidate alternative flight itineraries and corresponding flight times. The particular weather events include one or more of hurricanes, thunderstorms, or snowstorms. Determining particular candidate alternative flight itineraries as having high-risk connections comprises an estimate of delay for each connection based on the weather and comparing the estimated delay to a connection threshold. Providing one or more of the group of alternative flight itineraries for display includes providing an indicator for display with particular alternative flight itineraries indicating potential weather delays.

The foregoing and other embodiments can each optionally include one or more of the following features, alone or in combination. Determining one or more alternative flight itineraries includes determining current flight status information for a specified number of highest-ranked candidate alternative flight itineraries and filtering the highest-ranked candidate alternative flights based on the current flight status to generate a group of alternative flight itineraries. The obtained weather information includes weather predictions for particular weather events in proximity to connecting airport locations in the collection of candidate alternative flight itineraries and corresponding flight times. The particular weather events include one or more of hurricanes, thunderstorms, or snowstorms. Determining particular candidate alternative flight itineraries as having high-risk connections comprises an estimate of delay for each connection based on the weather and comparing the estimated delay to a connection threshold. Providing one or more of the group of alternative flight itineraries for display includes providing an indicator for display with particular alternative flight itineraries indicating potential weather delays. Providing one or more alternative flight itineraries for display includes ordering the one or more alternative flight itineraries according to the estimated actual times instead of scheduled times for each alternative flight itinerary.

Particular embodiments of the subject matter described in this specification can be implemented so as to realize one or more of the following advantages. Alternative flight itineraries can be generated that are based on information associated with weather conditions, e.g., at or near the origin and/or destination of a given flight. The alternative flight itineraries can be generated at any time during a user's travel, e.g., to identify alternative itineraries part way through travel, using up-to-date weather conditions and/or forecasts.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for performing re-accommodation of travel itineraries.

FIG. 2A is a block diagram showing example stages in a system for performing re-accommodation of travel itineraries.

FIG. 2B is a block diagram showing example stages for determining one or more alternative flight itineraries to the flight itinerary that is delayed or canceled.

FIG. 3A illustrates an example current itinerary user interface.

FIG. 3B illustrates an example alternative itineraries summary user interface.

FIG. 3C illustrates an example alternative itineraries detailed view user interface.

FIG. 4A is a flow diagram of an example method for performing re-accommodation of travel itineraries.

FIG. 4B is a flow diagram of an example method for determining one or more alternative flight itineraries to the flight itinerary that is delayed or canceled.

FIG. 4C is a flow diagram of an example method for determining one or more alternative flight itineraries based on predicted weather delay without actual cancellation or delay of a current flight.

Like reference numbers and designations in the various drawings indicate like elements.

### DETAILED DESCRIPTION

Systems, methods, and computer program products are described for performing re-accommodation of travel itineraries, such as flight itineraries associated with airline travel. For example, one or more flights of a user's flight itinerary are canceled or delayed due to weather or some other reason, suggested re-routing options, e.g., in the form of alternative flight itineraries, can be determined automatically and provided to the user. Different types of information and/or approaches can be used in determining the re-routing. For example, re-routing can be based, at least in part, on weather information, including current conditions at an airport or city, or weather forecasts that may affect any part of an itinerary or alternative itineraries.

In some implementations, re-routing options can take into account the user's preferences of avoiding certain airports (e.g., based on past experiences), or avoiding travel after a certain time-of-day (e.g., to avoid red-eye flights). In some implementations, re-routing can consider a user's preference to accept local accommodations rather than making different travel arrangements. In some implementations, a user's travel preferences can be stored and/or made available by an airline, a travel agency, an online or third-party source, or in some other way.

While the examples in this description focus primarily on airline travel and associated itineraries, other types of travel and itineraries can also be handled by the methods and systems described herein. For example, re-accommodation of airline itineraries can be integrated with other forms of transportation, such as rental car, taxi, bus, subway, train, boat, ferry and/or other arrangements or aspects of travel.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from a content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

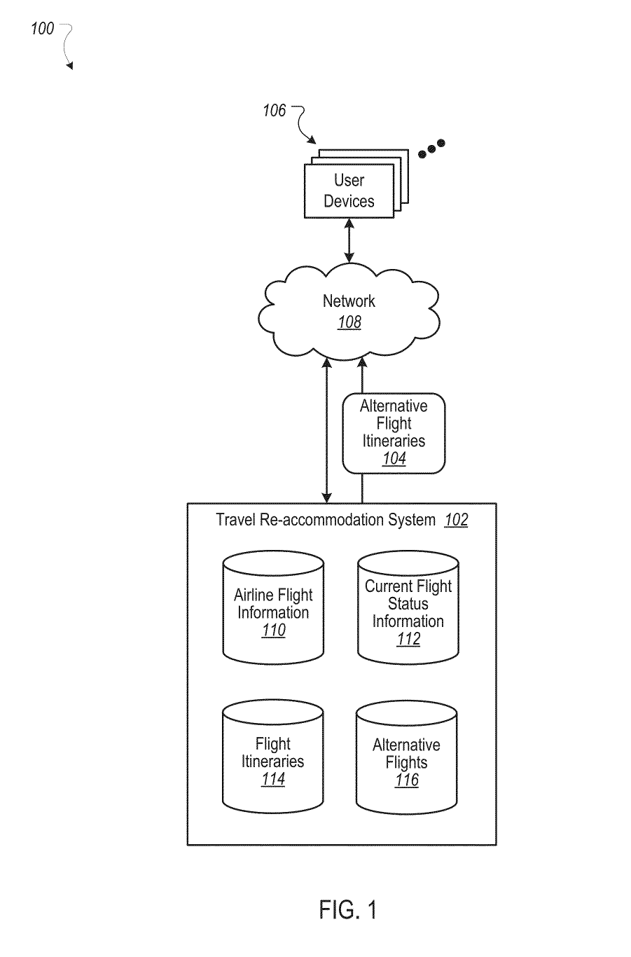

FIG. 1 is a block diagram of an example environment 100 for performing re-accommodation of travel itineraries. Re-accommodation, for example, can pertain to determining alternative itineraries, including different routes, and providing the alternative itineraries for presentation to a user. The environment 100 can include a travel re-accommodation system 102 that provides, for example, alternative flight itineraries 104 to user devices 106. For example, a user device 106 associated with a particular user can receive the alternative flight itineraries 104 for a flight itinerary for which the travel re-accommodation system 102 has determined alternative flight arrangements for the user, such as for a canceled or delayed flight. Communication between the user devices 106 and the travel re-accommodation system 102 can include the use of a network 108, such as a combination of the Internet, wide area networks (WANs), local area networks (LANs), other networks, or combinations thereof. User devices 106 can include, for example, mobile devices associated with the user, as well as kiosk computers at airports. Other configurations of the environment 100 are possible, including the use of external systems that provide information (e.g., weather information) to the travel re-accommodation system 102.

In some implementations, the travel re-accommodation system 102 can be a stand-alone application that runs, for example, on a user's user device 106. In some implementations, the travel re-accommodation system 102 can be provided on, or accessible from, a web page, such as provided by one or more airlines or provided by third-parties.

In some implementations, the environment 100 includes plural data stores that can be stored locally by the travel re-accommodation system 102, stored somewhere else and accessible using the network 108, generated as needed from various data sources, or some combination thereof. A data store of airline flight information 110, for example, includes information for flights associated with one or more air carriers, including general airline flight information and including information for specific flights for which there are user itineraries. For example, the information can include flight numbers/identifiers, scheduled departure/arrival dates/times, airport information, carrier information, equipment and personnel information, a set of dates on which the flight operates, and other information associated with each flight and/or its execution.

A data store of current flight status information 112, for example, includes real-time status information for each of the flights identified in the data store of airline flight information 110. For example, the real-time status information can identify which flights are currently (or forecast to be) on time, delayed, canceled or some other status. The status information can also include, for example, reasons contributing to a current status, such as reasons associated with equipment, personnel, weather, or some other reason. In some implementations, current flight status information can be received from airlines, received from third-party flight monitoring systems, monitored by the system, obtained in aggregated form from a third party, and/or received from other sources.

A data store of flight itineraries 114 can include information that identifies one or more flights that are included in each itinerary, such as on a per-user basis. The information can also include information identifying the user(s) with whom the flight itineraries are associated. Itinerary information can also monitor parts of each itinerary that are completed or in progress. For example, the information can indicate that User A has completed the leg of the itinerary that includes a flight from City B to City C. In some implementations, information stored in the data store of flight itineraries 114 can include user information, such as seating, airline, schedule, cost tolerance and/or other user preferences that can be used to determine alternative flights. In some implementations, information for flight itineraries and/or the itineraries themselves can be provided by the user, associated with a user profile, received from a booking/travel agency, or extracted (with permission from the user) from mail or calendar programs.

Alternative flight itineraries 116 can identify, for any given itinerary, one or more replacement flights that be substituted, e.g., as suggestions to the user, for one or more of an itinerary's planned flights. For example, one or more alternative flight can be determined and stored in the alternative flight itineraries 116, such as when it is determined that a scheduled flight in the itinerary is delayed or canceled. In some implementations, for a given flight, a set of candidate alternative flights can be determined and stored in the alternative flight itineraries 116. For example, an alternative flight can connect the same two airports with a single flight, or with two or more connecting flights. In some implementations, alternative flights can include one or more non-flight modes of transportation, such as rental car, taxi, bus, subway, train, boat or ferry.

In some implementations, the travel re-accommodation system 102 includes plural engines, some or all of which may be combined or separate, and may be co-located or distributed (e.g., connected over the network 108). A flight information engine, for example, can obtain current flight status information for a collection of flights. An itinerary evaluation engine can use current flight status information to determine that a flight itinerary associated with a particular user is delayed or canceled. An alternative flight itinerary engine, for example, can determine one or more alternative flight itineraries that include one or more alternative flights for a flight that is delayed or canceled. A user interface engine, for example, can provide one or more of the group of alternative flight itineraries for display on a user device. Other engines are possible, such as engines that are used to interface with external systems and engines that use various types of ways and/or inputs to determine alternative itineraries.

In some implementations, other engines can exist, e.g., for use in selecting alternative travel itineraries. An alternative flight itinerary identification engine, for example, can obtain a collection of candidate alternative flight itineraries that occur within a specified time frame and that correspond to an origin and a destination of the user's flight itinerary. A ranking engine, for example, can rank a collection of candidate alternative flight itineraries according to one or more criteria. A weather engine, for example, can obtain and use weather information to identify forecasted weather events and determine particular candidate alternative flight itineraries having high-risk connections. A weighting engine, for example, can weight the high-risk itineraries to generate a group of alternative flight itineraries.

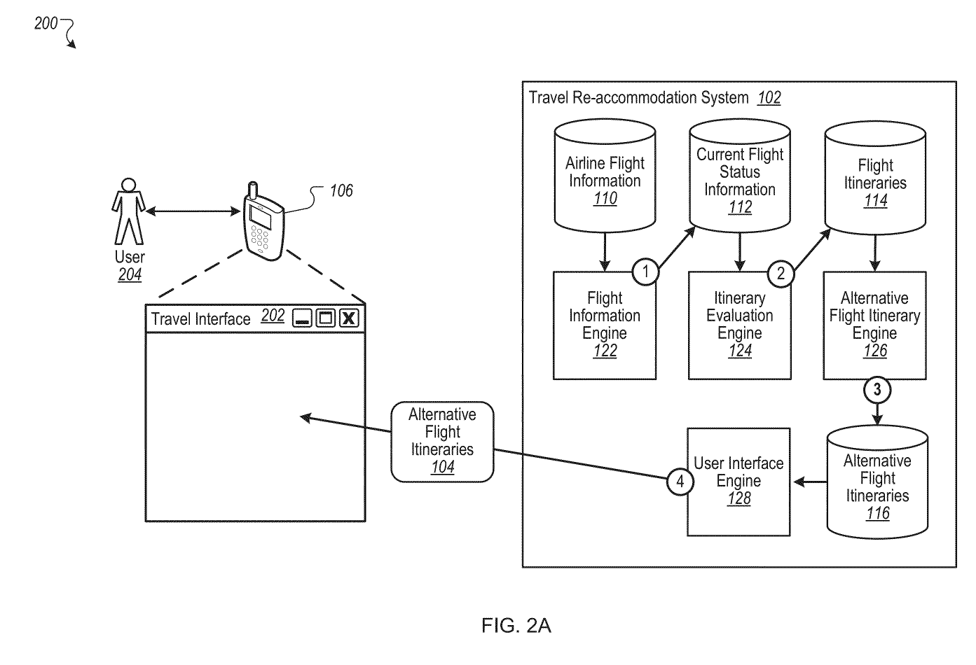

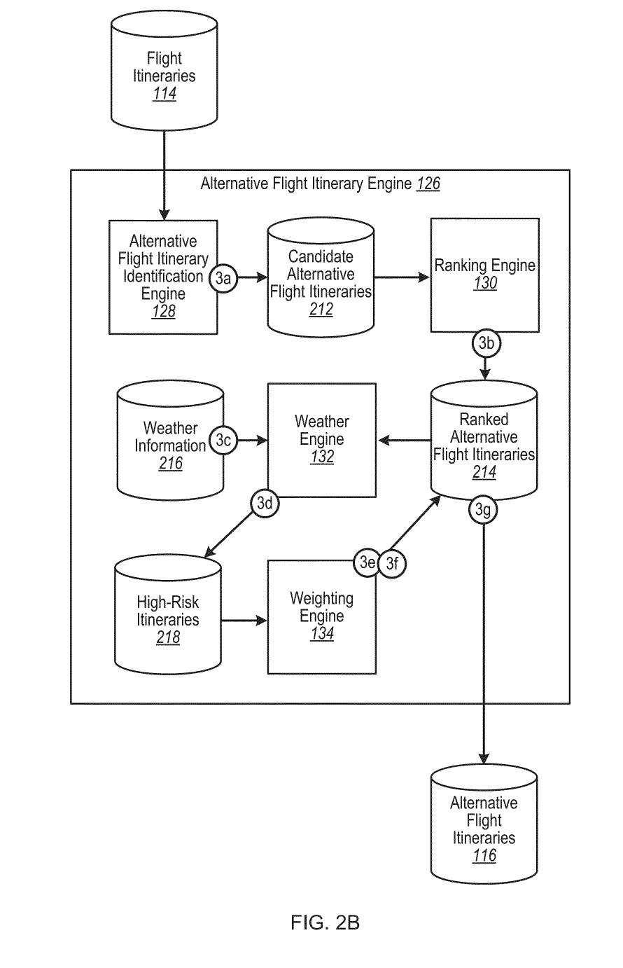

FIG. 2A is a block diagram showing example stages in a system 200 for performing re-accommodation of travel itineraries. For example, the system 200 can be used within the environment 100 described above. In some implementations, the system 200 can provide information for alternative flight itineraries for presentation in a travel interface 202 on the user device, such as for use by a user 204 with whom the alternative flight itineraries are associated.

At stage 1, a flight information engine 122 can obtain current flight status information 112 for a collection of flights, e.g., identified in the data store of airline flight information 110. For example, the flight information engine 122 can obtain or access information as to whether a particular flight is on time, delayed or canceled. The particular flight, for example, can be part of a travel itinerary associated with the user 204.

At stage 2, an itinerary evaluation engine 124 can use current flight status information to determine that a flight itinerary associated with a particular user (e.g., the user 204) is delayed or canceled. For example, for any flight that is determined by the flight information engine 122 to be delayed or canceled, the itinerary evaluation engine 124 can determine if matching flights exist in the data store of flight itineraries 114 that are associated with users. As a result, the itinerary evaluation engine 124 may identify that an in-progress itinerary for the user 204 includes Flight Y that has been canceled due to weather conditions in an associated airport. The user 204 may currently be on Flight X (e.g., that precedes Flight Y), or the user 204 may have already completed Flight X and is waiting to board Flight Y at a connecting airport.

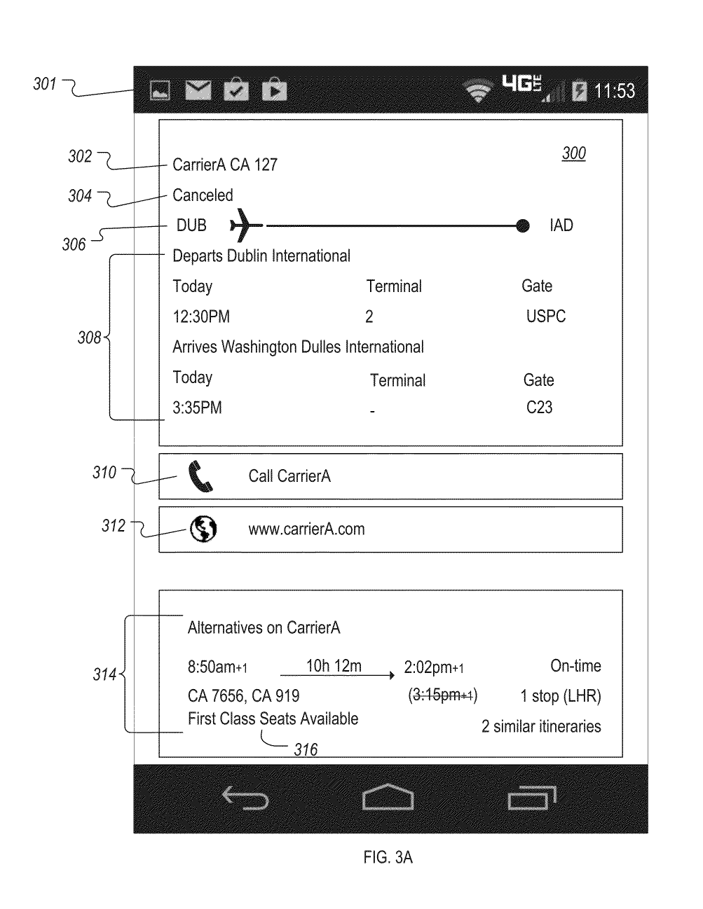

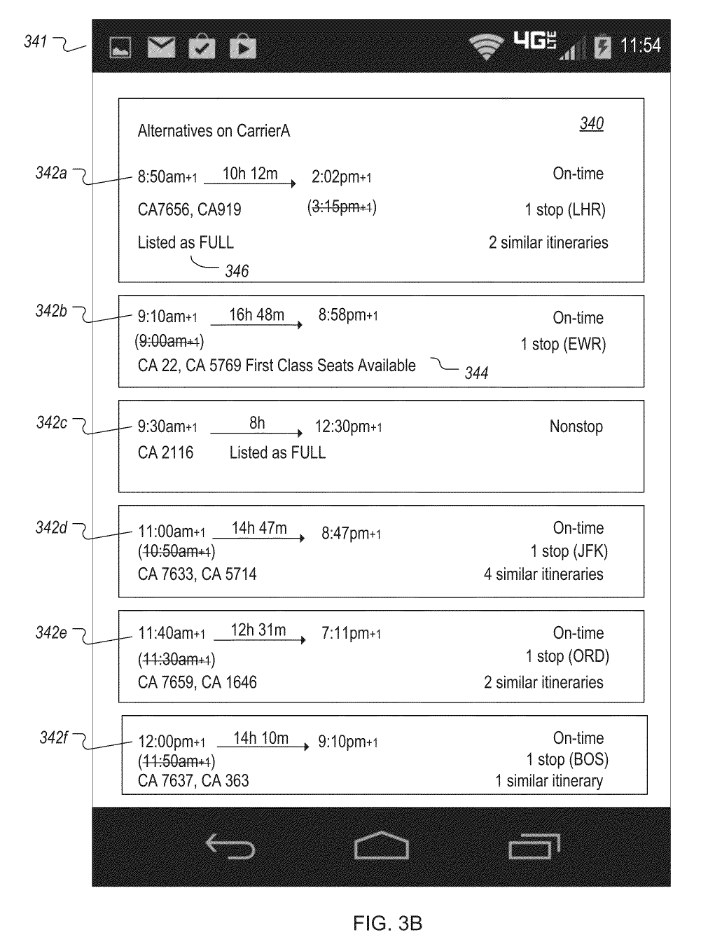

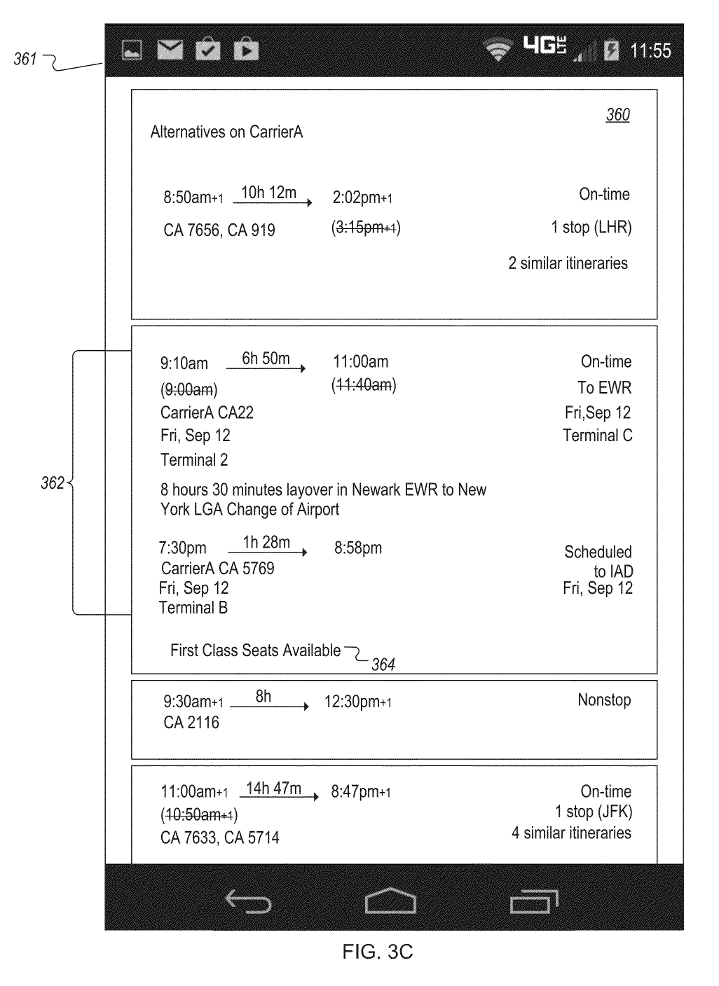

For example, FIG. 3A illustrates an example current itinerary user interface 300 displayed on a user device 301 and containing information for a flight itinerary associated with the particular user. The user interface 300 includes carrier and flight number information 302, current flight status 304 (e.g., on time, delayed, cancelled), and departure and arrival locations 306. A departure and arrival detail area 308 includes departure and arrival time, terminal, and gate information. Controls 310 and 312 can be used to view a web site of the carrier or to call the carrier, respectively. An alternatives area 314 includes information about one or more alternative itineraries to the current flight. As described below, in some implementations, the alternatives area 314 is displayed in response to receiving a notification that the current flight is delayed or cancelled. In some alternative implementations, if no determination has been made to provide alternatives based on the current flight status of the user's flight itinerary, the alternative area 314 can be omitted.

Referring again to FIG. 2A, at stage 3, an alternative flight itinerary engine 126 can determine one or more alternative flight itineraries that include one or more alternative flights for a flight that is delayed or canceled. For example, if Flight Y has been canceled due to weather conditions, the alternative flight itinerary engine 126 can determine one or more alternative flight itineraries that include a flight that services the same starting point and destination. In some implementations, the one or more alternative flight itineraries that are determined can include multiple flights, such as a pair of flights that connect in a connecting airport not included in the original itinerary for the user 204. For example, in reference to FIG. 3A, the current flight status can be updated.

In some implementations, determining alternative flight itineraries that are alternatives to the flight itinerary that is delayed or canceled can be based on weather information, as described below with reference to FIG. 2B.

At stage 4, a user interface engine 128 can provide one or more of the group of alternative flight itineraries for display on a user device. For example, the travel re-accommodation system 102 can provide one or more alternative flight itineraries 104 to the user device 106 of the user 204 whose flight itinerary is affected by the canceled flight. In some implementations, a received selection of a particular alternative flight itinerary can provide additional information about the itinerary. The additional information can include one or more indicators of purchasing options through one or more third-party booking providers. Alternatively, one or more indicators of purchasing options can be presented with each displayed alternative flight itinerary of the group of alternative flight itineraries. In reference to FIG. 3A, some or all of the alternative flight itineraries can be displayed in the alternatives area 314. In some implementations, alternative flight itinerary information can be pushed to a mobile device associated with the user and displayed as a notification, an e-mail, a text, or presented in some other type of user interface.

In some implementations, the user 204 can, for example, select a user interface control on a current itinerary view to view information about the alternative flight itineraries. For example, FIG. 3B illustrates an example alternative itineraries summary user interface 340 displayed on a user device 341. The alternative itineraries summary user interface 340 can be displayed automatically, for example, in response to the user device 341 receiving a notification that an itinerary of the user of the user device 341 has been delayed or cancelled. As another example, the alternative itineraries summary user interface 340 can be displayed in response to the user selecting a user interface control, such as a control included in the current itinerary user interface 300 described above with respect to FIG. 3A.

The alternative itineraries summary user interface 340 includes alternative itineraries 342a-342f. The alternative itineraries 342a-342f may be determined, for example, by an alternative flight itineraries determination engine (e.g., as described above with respect to FIG. 2A and below with respect to FIG. 2B). The alternative itineraries 342a-342f can be itineraries that are alternatives to a user itinerary that has been delayed or cancelled.

Although the alternative itineraries 342a-342f are each for a same carrier (e.g., “Carrier A”), the alternative itineraries summary user interface 340 can present itineraries from multiple carriers. For example, alternative itineraries for carriers that are partners with the carrier of the current itinerary can be presented.

The alternative itineraries 342a-342f can be sorted, for example, by departure time. Each of the alternative itineraries 342a-342f includes, for example, a scheduled departure time, a scheduled arrival time, a current flight status, an actual departure time (if applicable), an updated (e.g., estimated) arrival time (if applicable), flight code(s), and number of stops.

Other information can be included in an alternative itinerary 342a-342f. For example, in some implementations, an alternative itinerary 342a-342f can include an indication of seat availability. For example, an indicator 344 indicates that first-class seats may be available for the alternative itinerary 342b. As another example, an indicator 346 indicates that the alternative itinerary 342 may be full.

In some implementations, an alternative itinerary 342a-342f can be selected to view additional details about the selected alternative itinerary 342a-342f. For example, FIG. 3C illustrates an example alternative itineraries detailed view user interface 360 displayed on a user device 361. The alternative itineraries detailed view user interface 360 can be displayed, for example, in response to selection of an alternative itinerary 342a-342f as described above with respect to FIG. 3B. The alternative itineraries detailed view user interface 360 includes a detailed alternative itinerary area 362 which can be displayed, for example, in response to user selection of the alternative itinerary 342b of FIG. 3B. For example, the alternative itinerary 342b can expand into the detailed alternative itinerary area 362 in response to user selection of the alternative itinerary 342b. The detailed alternative itinerary area 362 includes, for example, information about travel legs (e.g., leg duration, departing and arriving terminals) and stops (e.g., intervening airports, stop duration).

In some implementations, processing performed by the system 200 can occur at different times. For example, processing can occur on a regular basis (e.g., every N minutes), or processing can occur when information is received that one or more flights is canceled or delayed. Other events can trigger processing, including, for example, a request by a user (e.g., the user 204) using the user device 106 who may be interested in alternative itineraries based on knowledge the user has about weather conditions in a scheduled destination.

FIG. 2B is a block diagram showing example stages for determining one or more alternative flight itineraries to the flight itinerary that is delayed or canceled. For example, FIG. 2B shows example sub-steps 3a-3g for stage 3 described above with reference to FIG. 2A for the alternative flight itinerary engine 126.

At stage 3a, an alternative flight itinerary identification engine 129 obtains a collection of candidate alternative flight itineraries 212 that occur within a specified time frame and that correspond to an origin and a destination of the user's flight itinerary. For example, the alternative flight itinerary identification engine 129 can determine one or more candidate alternative flight itineraries 212 that have flights with scheduled departures and/or arrivals within the specified time frame and based on the current geographical location and any completed portions of user's flight itinerary.

At stage 3b, a ranking engine 130 ranks the collection of candidate alternative flight itineraries 212 according to one or more criteria, e.g., creating ranked alternative flight itineraries 214. The one or more criteria can include, e.g., various times associated travel and/or layover times associated with an itinerary, likelihoods that alternative flights will be on time, cost factors, adherence to the user's travel preferences, and how likely the user is to be able to be on time for a departure. In some implementations, ranking can include sorting alternative flights, including grouping and sorting alternative flights by same airline, partner airline, and/or other airline categories.

At stage 3c, a weather engine 132 obtains weather information 216, such as from external weather-related sources. The weather information that is obtained can identify particular weather events including, for example, hurricanes, thunderstorms, snowstorms or other types of meteorological events or conditions. The weather information can also identify forecasted events in addition to in-progress events and/or past weather events that may have resulted in residual conditions, e.g., precipitation accumulations, flooding, wind damage, power outages, and/or other conditions or problems.

At stage 3d, the weather engine 132 uses the obtained weather information, in combination with the ranked alternative flight itineraries 214, to determine particular candidate alternative flight itineraries having high-risk connections. In some implementations, the candidate alternative flight itineraries having high-risk connections are included in a data store of high-risk itineraries 218.

At stage 3e, a weighting engine 134 weights the high-risk itineraries 218 to generate a group of alternative flight itineraries. For example, the group of alternative flight itineraries that are identified can be particular ones of the ranked alternative flight itineraries 214 that are now weighted based on weather-related risk.

At stage 3f, the weighting engine 134 adjusts the ranking of the ranked alternative flight itineraries 214 based on the weather-related risk weighting. For example, a particular flight itinerary can have its ranking lowered based on a weight associated with a weather-related risk.

At stage 3g, the alternative flight itinerary engine 126 selects a specified number of highest-ranked candidates to generate a group of the alternative flight itineraries 116. For example, the alternative flight itinerary engine 126 can select one or more highest-ranked alternative flight itineraries 214, e.g., to produce the alternative flight itineraries 116.

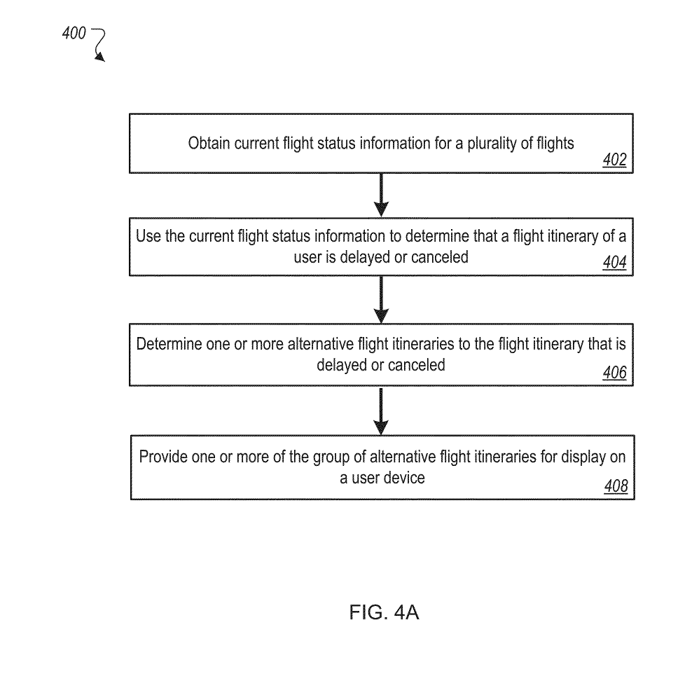

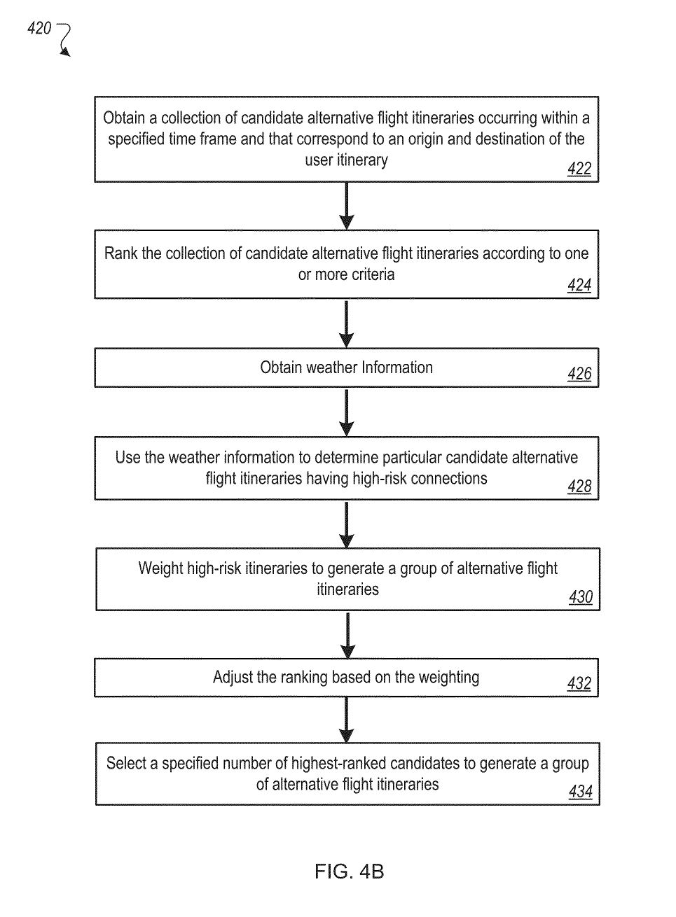

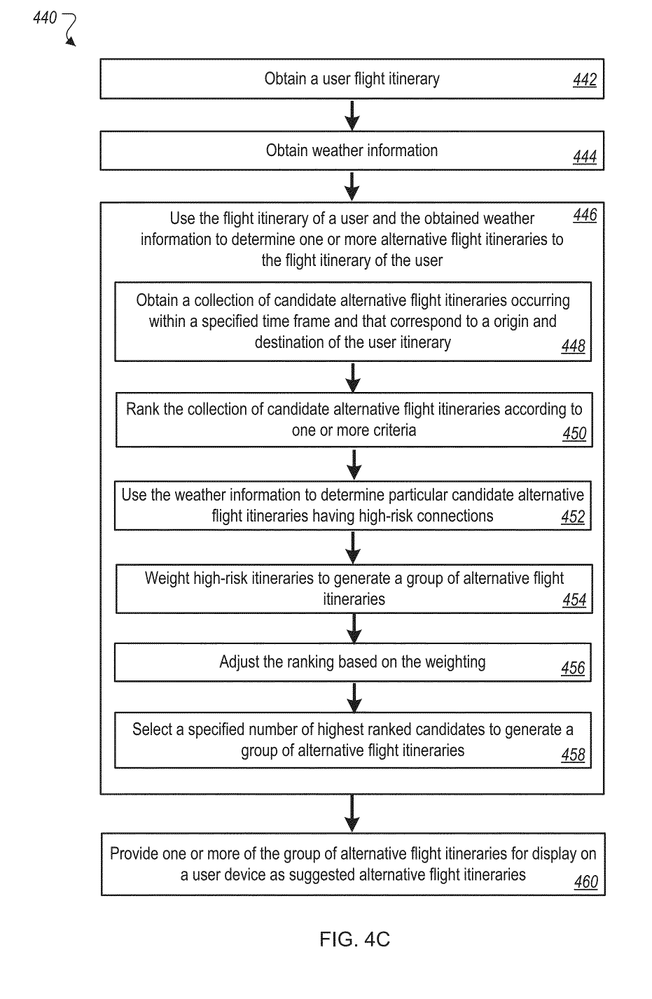

FIG. 4A is a flow diagram of an example method 400 for performing re-accommodation of travel itineraries. For convenience, the method 400 will be described with respect to a system, including one or more computing devices, that performs the method 400. For example, the method 400 can be performed by a travel re-accommodation system, such as in the travel re-accommodation system 102.

Current flight status information for a plurality of flights is obtained (step 402). As an example, the flight information engine 122 can obtain or access information as to whether a particular flight is on time, delayed or canceled, e.g., using information from the data store of airline flight information 110.

The current flight status information is used to determine that a flight itinerary of a user is delayed or canceled (step 404). The itinerary evaluation engine 124, for example, can use current flight status information to determine that a flight itinerary associated with a particular user is delayed or canceled. For example, the determination can be made by matching flights identified as being delayed or canceled with flights in the data store of flight itineraries 114.

One or more alternative flight itineraries are determined that are alternatives to the flight itinerary that is delayed or canceled (step 406). For example, the alternative flight itinerary engine 126 can determine one or more alternative flight itineraries that include one or more alternative flights for a flight that is delayed or canceled, as described above.

In some implementations, determining one or more alternative flight itineraries comprises determining current flight status information for a specified number of highest-ranked candidate alternative flight itineraries and filtering the highest-ranked candidate alternative flights based on the current flight status to generate a group of alternative flight itineraries. For example, the alternative flight itinerary engine 126 can select a group of alternative flight itineraries from among highest-ranked itineraries that are ranked using weather-related information, with a lower ranking being assigned to itineraries that are most affected by weather.

In some implementations, determining alternative flight itineraries are that are alternatives to the flight itinerary that is delayed or canceled can be based on weather information, as described below with reference to FIG. 4B.

One or more of the group of alternative flight itineraries are provided for display on a user device (step 408). The user interface engine 128, for example, can provide one or more of the group of alternative flight itineraries for display on the user device 106 of the user whose flight itinerary is affected by the canceled flight.

In some implementations, providing one or more of the group of alternative flight itineraries for display includes providing an indicator for display with particular alternative flight itineraries indicating potential weather delays. For example, the user interface engine 128 can include, with the one or more alternative flight itineraries 104 provided to the user device 106, information that indicates airport changes. When the information is presented in the travel interface 202, for example, changes in airports can be highlighted or otherwise indicated in the display.

In some implementations, providing one or more alternative flight itineraries for display includes ordering the one or more alternative flight itineraries according to the estimated actual times instead of scheduled times for each alternative flight itinerary. For example, information included with the one or more alternative flight itineraries 104 can be used in presenting the alternative flight itineraries in order by scheduled start time of the respective itinerary. In some implementations, other ways of presenting the itineraries can be used, including, for example, presenting scores that can indicate how well each respective itinerary meets the user's schedule, the user's preferences, the user's budget, an respective airport's ease and/or history of making a connecting flight, and/or other factors that can be scored.

FIG. 4B is a flow diagram of an example method 420 for determining one or more alternative flight itineraries to the flight itinerary that is delayed or canceled. For convenience, the method 420 will be described with respect to a system, including one or more computing devices, that performs the method 420. For example, the method 420 can be performed by the system 200, such as in the environment 100.

The system obtains a collection of candidate alternative flight itineraries that occur within a specified time frame and that correspond to an origin and destination of the user itinerary (step 422). An alternative flight itinerary identification engine, e.g., alternative flight itinerary identification engine 129, can obtain a collection of candidate alternative flight itineraries, e.g., from the candidate alternative flight itineraries 212, that occur within a specified time frame and that correspond to an origin and a destination locations of the user's flight itinerary, as described above. The one or more candidate alternative flight itineraries that are determined can include flights, for example, with scheduled departures and/or arrivals within the specified time frame and based on the current geographical location and any completed portions of user's flight itinerary.

The system ranks the collection of candidate alternative flight itineraries according to one or more criteria (step 424). As an example, a ranking engine, e.g., the ranking engine 130, can rank the collection of candidate alternative flight itineraries according to one or more criteria. In some implementations, the ranking criteria can include, for example, various times associated travel and/or layover times associated with an itinerary, likelihoods that alternative flights will be on time, cost factors, adherence to the user's travel preferences, and how likely the user is to be able to be on time for a departure.

The system obtains weather information (step 426). For example, a weather engine, e.g., weather engine 132, can obtain weather information, e.g., weather information 216, from one or more external weather-related sources. The weather information can include information about particular weather events including, for example, hurricanes, thunderstorms, snowstorms and other types of meteorological events.

In some implementations, the obtained weather information includes weather predictions for particular weather events in proximity to connecting airport locations in the collection of candidate alternative flight itineraries and corresponding flight times. For example, weather information that is obtained can include specific current and forecasted weather conditions that are specific to the airports associated with the connecting airport locations. In another example, the weather information can be regional information, e.g., that is associated with a region that geographically includes a particular city and/or airport.

The system uses the weather information to determine particular candidate alternative flight itineraries having high-risk connections (step 428). For example, the weather engine can use the obtained weather information to determine, from the ranked alternative flight itineraries, a collection of particular candidate alternative flight itineraries that have high-risk connections, e.g., the data store of high-risk itineraries 218.

In some implementations, determining particular candidate alternative flight itineraries as having high-risk connections includes estimating a delay for each connection based on the weather and comparing the estimated delay to a connection threshold. For each high-risk connection, for example, the weather engine can use the weather information associated with a particular connection to identify an estimated delay. The estimated delay can be based on various factors including, e.g., delays of previous/current flights at the same connection, time-of-day analysis (e.g., including how busy an airport is at a given time), delays identified by numbers of planes currently waiting (e.g., to take off, land, de-plane, fueling, servicing, de-icing), and/or historical information.

The system weights high-risk itineraries to generate a group of alternative flight itineraries (step 430). For example, a weighting engine, e.g., weighting engine 134, can weight the high-risk itineraries to update particular ones of the ranked alternative flight itineraries with weights based on weather-related risk.

The system adjusts the ranking based on the weighting (step 432). The weighting engine, for example, can adjust the ranking of the ranked alternative flight itineraries based on the weather-related risk weighting, e.g., lowering a particular flight itinerary's ranking based on a weight associated with a weather-related risk.

The system selects a specified number of highest-ranked candidates to generate a group of alternative flight itineraries (step 434). As an example, an alternative flight itinerary engine, e.g., the alternative flight itinerary engine 126, can select a specified number of highest-ranked candidates to generate a group of the alternative flight itineraries, e.g., alternative flight itineraries 116, for presentation to the user.

FIG. 4C is a flow diagram of an example method 440 for determining one or more alternative flight itineraries based on predicted weather delay without actual cancellation or delay of a current flight. For convenience, the method 440 will be described with respect to a system, including one or more computing devices, that performs the method 440. For example, the method 440 can be performed by the system 200, such as in the environment 100.

The system obtains a user flight itinerary (step 442). An alternative flight itinerary identification engine, e.g., alternative flight itinerary identification engine 129, can obtain the current flight itinerary of a user. The flight itinerary may have no existing associated delays and/or cancellations, but can be chosen by the user for generation of alternative flight itineraries anyway.

The system obtains weather information (step 444). For example, a weather engine, e.g., weather engine 132, can obtain weather information from one or more external weather-related sources. The weather information can identify particular weather events such as hurricanes, thunderstorms and snowstorms.

The system uses the flight itinerary of a user and the obtained weather information to determine one or more alternative flight itineraries to the flight itinerary of the user (step 446). For example, the weather engine can use the obtained weather information and information associated with the user's itinerary to determine alternative flight itineraries, such as using processing associated with one or more of the following steps 448-458.

The system obtains a collection of candidate alternative flight itineraries for itineraries that occur within a specified time frame and that correspond to an origin and destination of the user itinerary (step 448). An alternative flight itinerary identification engine, e.g., alternative flight itinerary identification engine 129, can obtain a collection of candidate alternative flight itineraries that occur within a specified time frame and that correspond to an origin and a destination of the user's flight itinerary, as described above.

The system ranks the collection of candidate alternative flight itineraries according to one or more criteria (step 450). A ranking engine, e.g., ranking engine 130, can rank the collection of candidate alternative flight itineraries according to one or more criteria. The resulting ranked alternative flight itineraries may be ranked according to one or more criteria, such as various times associated travel and/or layover times associated with an itinerary, likelihoods that alternative flights will be on time, cost factors, adherence to the user's travel preferences, and how likely the user is to be able to be on time for a departure.

The system uses the weather information to determine particular candidate alternative flight itineraries having high-risk connections (step 452). As an example, the weather engine can use the obtained weather information to determine, from the ranked alternative flight itineraries, a collection of particular candidate alternative flight itineraries that have high-risk connections, e.g., producing the data store of high-risk itineraries.

The system weights the high-risk itineraries to generate a group of alternative flight itineraries (step 454). A weighting engine, e.g., weighting engine 134, can weight the high-risk itineraries to update particular ones of the ranked alternative flight itineraries with weights based on weather-related risk.

The system adjusts the ranking based on the weighting (step 456). For example, the weighting engine can adjust the ranking of the ranked alternative flight itineraries 24 based on the weather-related risk weighting, e.g., lowering a particular flight itinerary's ranking based on a weight associated with a weather-related risk.

The system selects a specified number of highest-ranked candidates to generate a group of alternative flight itineraries (step 458). An alternative flight itinerary engine, e.g., alternative flight itinerary engine 126, can select a specified number of highest-ranked candidates to generate a group of the alternative flight itineraries for presentation to the user.

The system provides one or more of the group of alternative flight itineraries for display on a user device as suggested alternative flight itineraries (step 460). For example, a user interface engine, e.g., user interface engine 128, can provide one or more of the group of alternative flight itineraries for display on a user device associated with a particular user.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded using, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
obtaining current flight status information for a plurality of flights;
using the current flight status information to determine that a flight itinerary of a user is delayed or canceled;
determining one or more alternative flight itineraries to the flight itinerary that is delayed or canceled, comprising:
obtaining a collection of candidate alternative flight itineraries occurring within a specified time frame and that correspond to an origin and destination of the user itinerary,
ranking the collection of candidate alternative flight itineraries according to one or more criteria,
obtaining weather information,
using the weather information to determine particular candidate alternative flight itineraries having high-risk connections,
weighting high-risk itineraries to generate a group of alternative flight itineraries;
adjusting the ranking based on the weighting, and
selecting a specified number of highest-ranked candidates to generate a group of alternative flight itineraries; and
providing one or more of the group of alternative flight itineraries for display on a user device.

2. The method of claim 1, wherein determining one or more alternative flight itineraries comprises:
determining current flight status information for a specified number of highest-ranked candidate alternative flight itineraries; and
filtering the highest-ranked candidate alternative flights based on the current flight status to generate a group of alternative flight itineraries.

3. The method of claim 1, wherein the obtained weather information includes weather predictions for particular weather events in proximity to connecting airport locations in the collection of candidate alternative flight itineraries and corresponding flight times.

4. The method of claim 3, wherein the particular weather events include one or more of hurricanes, thunderstorms, or snowstorms.

5. The method of claim 1, wherein determining particular candidate alternative flight itineraries as having high-risk connections comprises an estimate of delay for each connection based on the weather and comparing the estimated delay to a connection threshold.

6. The method of claim 1, wherein providing one or more of the group of alternative flight itineraries for display includes providing an indicator for display with particular alternative flight itineraries indicating potential weather delays.

7. The method of claim 1, wherein providing one or more alternative flight itineraries for display includes ordering the one or more alternative flight itineraries according to the estimated actual times instead of scheduled times for each alternative flight itinerary.

8. A method comprising:
obtaining a user flight itinerary;
obtaining weather information;
using the flight itinerary of a user and the obtained weather information to determine one or more alternative flight itineraries to the flight itinerary of the user, comprising:
obtaining a collection of candidate alternative flight itineraries occurring within a specified time frame and that correspond to an origin and destination of the user itinerary,
ranking the collection of candidate alternative flight itineraries according to one or more criteria,
using the weather information to determine particular candidate alternative flight itineraries having high-risk connections,
weighting high-risk itineraries to generate a group of alternative flight itineraries;
adjusting the ranking based on the weighting, and
selecting a specified number of highest-ranked candidates to generate a group of alternative flight itineraries, and
providing one or more of the group of alternative flight itineraries for display on a user device as suggested alternative flight itineraries.

9. A system comprising:
one or more computers configured to perform operations comprising:
obtaining current flight status information for a plurality of flights;
using the current flight status information to determine that a flight itinerary of a user is delayed or canceled;
determining one or more alternative flight itineraries to the flight itinerary that is delayed or canceled, comprising:
obtaining a collection of candidate alternative flight itineraries occurring within a specified time frame and that correspond to an origin and destination of the user itinerary,
ranking the collection of candidate alternative flight itineraries according to one or more criteria,
obtaining weather information,
using the weather information to determine particular candidate alternative flight itineraries having high-risk connections,
weighting high-risk itineraries to generate a group of alternative flight itineraries;
adjusting the ranking based on the weighting, and
selecting a specified number of highest-ranked candidates to generate a group of alternative flight itineraries; and
providing one or more of the group of alternative flight itineraries for display on a user device.

10. The system of claim 9, wherein determining one or more alternative flight itineraries comprises:
determining current flight status information for a specified number of highest-ranked candidate alternative flight itineraries; and
filtering the highest-ranked candidate alternative flights based on the current flight status to generate a group of alternative flight itineraries.

11. The system of claim 9, wherein the obtained weather information includes weather predictions for particular weather events in proximity to connecting airport locations in the collection of candidate alternative flight itineraries and corresponding flight times.

12. The system of claim 11, wherein the particular weather events include one or more of hurricanes, thunderstorms, or snowstorms.

13. The system of claim 9, wherein determining particular candidate alternative flight itineraries as having high-risk connections comprises an estimate of delay for each connection based on the weather and comparing the estimated delay to a connection threshold.

14. The system of claim 9, wherein providing one or more of the group of alternative flight itineraries for display includes providing an indicator for display with particular alternative flight itineraries indicating potential weather delays.

15. A computer storage medium encoded with a computer program, the program comprising instructions that when executed by one or more computers cause the one or more computers to perform operations comprising:
obtaining current flight status information for a plurality of flights;
using the current flight status information to determine that a flight itinerary of a user is delayed or canceled;
determining one or more alternative flight itineraries to the flight itinerary that is delayed or canceled, comprising:
obtaining a collection of candidate alternative flight itineraries occurring within a specified time frame and that correspond to an origin and destination of the user itinerary,
ranking the collection of candidate alternative flight itineraries according to one or more criteria,
obtaining weather information,
using the weather information to determine particular candidate alternative flight itineraries having high-risk connections,
weighting high-risk itineraries to generate a group of alternative flight itineraries;
adjusting the ranking based on the weighting, and
selecting a specified number of highest-ranked candidates to generate a group of alternative flight itineraries; and
providing one or more of the group of alternative flight itineraries for display on a user device.

16. The computer storage medium of claim 15, wherein determining one or more alternative flight itineraries comprises:
determining current flight status information for a specified number of highest-ranked candidate alternative flight itineraries; and
filtering the highest-ranked candidate alternative flights based on the current flight status to generate a group of alternative flight itineraries.

17. The computer storage medium of claim 15, wherein the obtained weather information includes weather predictions for particular weather events in proximity to connecting airport locations in the collection of candidate alternative flight itineraries and corresponding flight times.

18. The computer storage medium of claim 17, wherein the particular weather events include one or more of hurricanes, thunderstorms, or snowstorms.

19. The computer storage medium of claim 15, wherein determining particular candidate alternative flight itineraries as having high-risk connections comprises an estimate of delay for each connection based on the weather and comparing the estimated delay to a connection threshold.

20. The computer storage medium of claim 15, wherein providing one or more of the group of alternative flight itineraries for display includes providing an indicator for display with particular alternative flight itineraries indicating potential weather delays.
